(19) United States
(12) Patent Application Publication
(10) Pub. No.: US 2004/0140403 A1
(43) Pub. Date: Jul. 22, 2004

(54) Asymetric gravitational wave propulsion system

(76) Inventor: Jeffrey A Cameron, Taft, TN (US)

Correspondence Address: BRADLEY ARANT ROSE & WHITE LLP, 200 CLINTON AVE. WEST, SUITE 900, HUNTSVILLE, AL, 35801, US

(21) Appl. No.: 10/363,287

(22) PCT Filed: Sep. 5, 2001
(86) PCT No.: PCT/US01/27660

(30) Foreign Application Priority Data
Sep. 5, 2000 (US) 60229819

(51) Int. Cl. B64G 1/42

(52) U.S. Cl. 244/172

(57) ABSTRACT

Gravitational Wave Radiation is generated by the quadruple moment of matter that is in motion. A plurality of laser diodes (7) are energized to emit vibratory energy which energizes an array of linear vibrators (6) which are used to propel a vehicle in space.

### TECHNICAL FIELD

The present invention is directed to a space propulsion system that is propellantless. The propelling force of a space vehicle is generated by means of generating asymmetric gravitation waves, thus creating a momentum imbalance through the center of mass of the radiating system. This causes a force to act upon said center of mass, resulting in motion in the direction of the least intense gravitational wave.

### BACKGROUND ART

Einstein derived the weak-field solution of the gravitational wave in accordance with the general and special theories of relativity. This scientific background is used herein to describe a revolutionary new approach to propulsion. Programmable laser diodes in conjunction with semiconductor materials are used to generate a highly directional transverse wave gravitational wave (TWGW) radiator. This asymmetric TWGW radiator will create a directional force through the center of mass of the radiating system, thus forming a propellantless propulsion system.

### DISCLOSURE OF THE INVENTION

Theoretical work indicates the ability to generate gravitational wave radiation through the quadruple moment of matter under stress and strain. The radiation pattern is symmetric about the center of the mass, and the direction of the pattern is at right angles to the stress and strain vector. The radiation pattern looks like a torus. The radiated power is very small; however, when a linear sequence of radiators is put together and their patterns are allowed to superimpose, the total radiated power can approach very high powers. The asymmetry of the radiated pattern is produced by adjusting the phase of the radiators. The resulting power imbalance will produce a force through the center of mass of the radiators. In order to accomplish this task, high peak power laser diodes will be used to photo-acoustically drive thin-film resonators.

Consider the following. Let η_{,uv} be a Lorentz metric, then the Riemannian metric is expressed as

g_{,uv}=η_{,uv}\sqrt{Kh_{,uv}}

as a first approximation under the weak field assumptions, K is

Einsties's constant. The potenial of the field can be expressed as

$${Φ}_{uv} = {h}_{uv} - \frac{1}{2} {η}_{un} h$$

resulting in the form for 4-space

[]Φ^{aB}=2\sqrt{KT^{aB}}

with retarded potential solutions of the form

Φ^{uv}(x)≡(\sqrt{K/2}π∫T^{uv}(x^{l},x⁰)

This form will enable the definition of the energy-momentum complex of the gravitational field in order to evaluate the radiation energy and directivity of the gravitational wave.

The Poynting vector of the gravitational wave can be expressed as

$${U}_{o}^{l} = \frac{1}{8} ( - 2 {Φ}^{ρσ , l} {Φ}_{ρσ , o} + {Φ}^{, l} {Φ}_{, o} )$$

The derivatives of the potential fields Φ with respect to time and space coordinates are expressed by the second and third derivatives of the mass tensor,

mc²=∫∫∫T⁰⁰(x′,x_{G}⁰)d³x′

momentum tensor,

cP^{K}=δ₀x^{K}∫∫∫T⁰⁰(x′,x_{G}⁰)d³x′

and the quadruple moment tensor,

I^{1K}=x′x^{K′}∫∫∫T₀₀(x′,x_{G}⁰)d³x′

The derivative forms for the potential fields are substituted into the expression for the Poynting vector, thus giving the expression for the radiated energy per unit time, or power, within a solid angle dΩ, as follows.

$${P}_{o}^{l} = {U}_{o}^{l} d {σ}_{e} = \frac{1}{8} {( \frac{\sqrt{K}}{4 π} )}^{2} f ( θ , Φ , {x}_{G}^{o} ) d Ω$$

Here the factor

f(θ,Φ,x_{G}⁰)

represents the directivity of the gravitational wave radiator.

Of particular interest is the resonance vibrator, conceptually similar to what has been used as a gravitational wave detector. The resonance vibrator is placed under stress and strain along the z axis.

At this point assume the following dynamic variables

Displacement

$$ϵ = A , sin ( \frac{ω}{{V}_{s}} ) cos wt$$

Particle velocity

$$v = \frac{ⅆ ξ}{ⅆ t} = {V}_{p} sin ( \frac{ω}{{V}_{s}} ) z sin wt$$

Strain

$$ϵ ⩵ \frac{ⅆ ξ}{ⅆ z} = \frac{{V}_{p}}{{V}_{s}} cos ( \frac{ω}{{V}_{s}} ) z cos wt$$

Vₚ=A,ω

$${V}_{p} = {( \frac{{B}_{s}}{ρ} )}^{\frac{1}{2}}$$

B₂→Young's Modulus

The directivity can now be expressed as follows.

f˜sin⁴ θ

The radiating pattern resembles a torus or “donut” mode, and the maximum radiation occurs in the plane perpendicular to the vibrating z axis.

Consider the linear array of resonant vibrators. Let high peak power laser radiation from laser diodes be injected along the z axis to induce acoustic stress in the material.

The stresses will generate a weak gravitational wave along the x axis. The gravitational wave generated from a number of “cells” along the x axis can be added in phase. The resultant gravitational “beam” along the x axis is extremely intensified compared to a single resonant vibrator “cell.” The linear arrangement will be referred to as a traveling wave (TW) gravitational wave (GW) radiator, or TWGW radiator.

The directivity of the TWGW radiator can be expressed as

$$f \approx {( \frac{sin ( \frac{πω}{{V}_{s}} ( 1 - cos Θ ) )}{( \frac{πω}{{V}_{s}} ) ( 1 - cos Θ )} )}^{2} {cos}^{4} Θ$$

The TWGW radiation is very directional. The radiated power can be estimated by the following expression.

$${P}_{TW} = ( 7 \times {10}^{- 5} ) G {ρ}_{o}^{2} {a}^{2} {l}^{2} {e}_{m}^{2} {{V}_{s} ( \frac{{V}_{s}}{C} )}^{5} {( \frac{b ω}{{V}_{s}} )}^{6} Ω$$

Where

G=Gravitational Constant

E_{M}=Strain

Ω=Solid Angle of Radiation

b=Cell Thickness

a=Cell Width and Length

∂=Array Length

\overline{ω}=Cell Resonant Frequency

Vₛ=Acoustic Velocity

ρ₀=Cell Density

This shows how important the phase relationships between individual resonant vibrators are!

At this point it is important to realize that the radiated gravitational wave carries energy and momentum with it. This is expressed as

$$P = \frac{ϵ}{C} = \frac{\underline{P} t}{C}$$

where P is the radiated power, t is time, ^{ε} is the energy of the gravitational wave, and P is the momentum.

The resulting reaction force on the TWGW structure is expressed as

$$F = \frac{P}{t} = \frac{\underline{P}}{C}$$

The radiation pattern is symmetric about the center of the TWGW structure. Therefore any reaction force is balanced. However, consider a variation in the phasing of the laser diodes, where the lobes become asymmetric.

This can be accomplished by pulse timing, variation in pulse rate, laser diode intensity, alternate materials, and geometry. Here there is a net force in the direction of the least intense gravitational wave.

The reaction force is expressed as space propulsion system, using a resonant vibrator array driven by laser diodes/fiber optics.

It is an object of the present invention to provide an asymmetric gravity wave propulsion system for propelling a vehicle in space.

Another object of the invention is to provide an apparatus for containing the resonant vibrator array, having the form of a pod.

A further object of the invention is to provide an apparatus that contains payload, power, and control, and that provides a mechanical attachment point for the pods by means of a pylon.

FIG. 1 is a representation of a basic linear resonant vibrator array (6). Individual resonant vibrator cells are placed together to create a linear structure, and hence a linear resonant vibrator array (6). The top and bottom are along the z axis, the sides are along the y axis, and the array length is along the x axis.

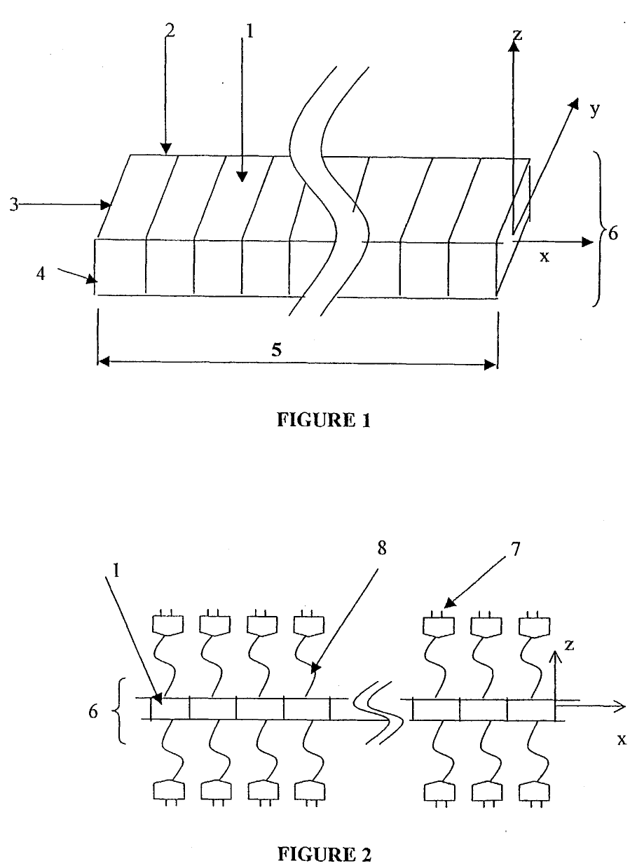

FIG. 2 is a side view of FIG. 1 also the y axis with the exception that the high-power laser diodes and fiber optics are depicted attached along the z axis to the top and bottom of the array.

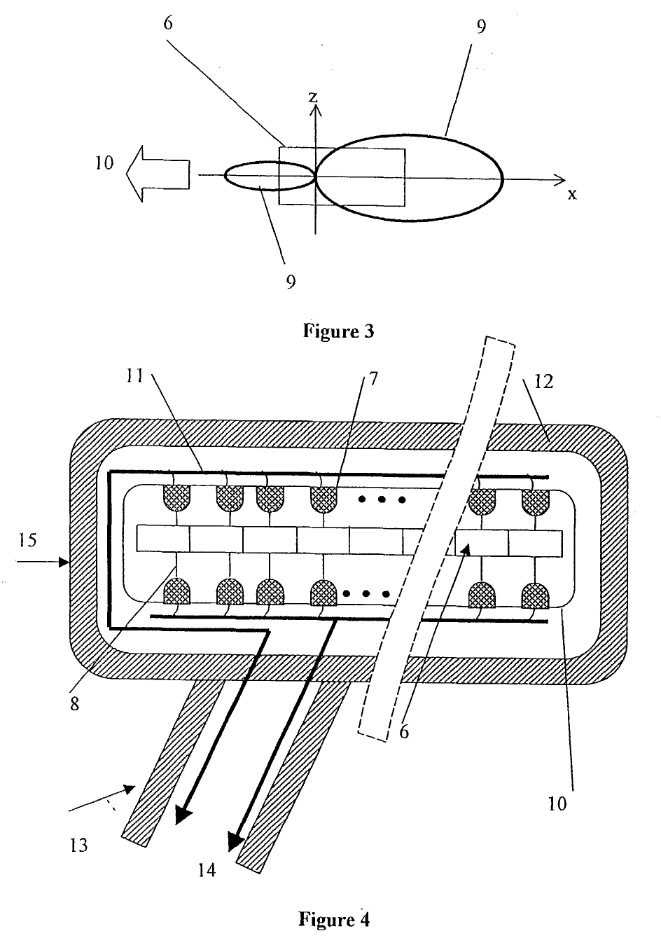

FIG. 3 is a side view of FIG. 1, illustrating the asymmetric radiation pattern generated by appropriate phasing of the laser diodes of FIG. 2. The asymmetric radiation pattern is shown to create a net reaction force along the x axis.

FIG. 4 is a side view of a structure called a pod that houses the resonant vibrator array and laser diode/fiber optic assemblies.

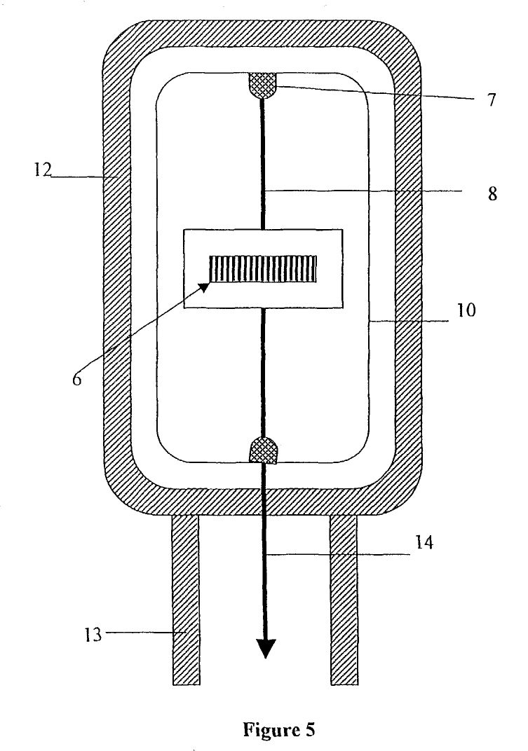

FIG. 5 is a front/back view of FIG. 4.

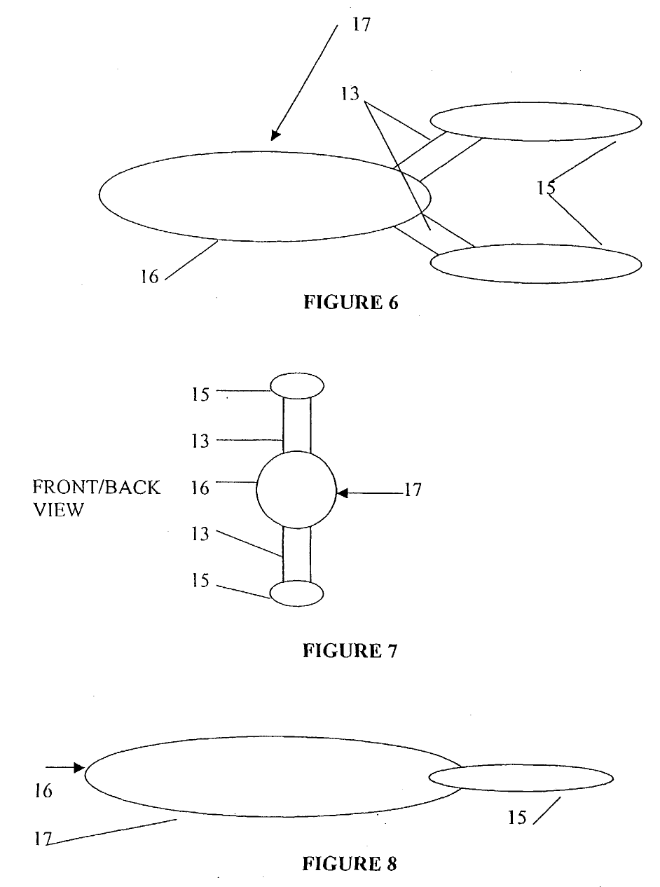

FIG. 6 is a vehicle containing a payload/power section, propulsion pods, and pylon attachment means.

FIG. 7 is a front/back view of FIG. 6.

FIG. 8 is a top/bottom view of FIG. 6.

### BEST MODE FOR CARRYING OUT THE INVENTION

As seen in FIG. 1, a resonant vibrator array (6) is comprised of resonant vibrator cells (1), having length (2), width (3), and depth (4). The cells (1) are arranged in a linear fashion, creating a linear resonant vibrator array (6) of length (5).

As seen in FIG. 2, a high-power laser diode (7) and fiber optic (8) are attached to a resonant vibrator cell (1) on the top and bottom. Each cell (1) in the array (6) is constructed in the same manner.

The asymmetric gravitational wave radiation pattern (9) is depicted in FIG. 3 with respect to the array (6) and the resulting directional force (10).

As seen in FIG. 4, the array (6), laser diodes (7), and fiber optic (8) are interfaced in a support structure (10) with a buss for power/control (11). All are contained in a pod enclosure (15). The power command and control (14) is provided through the mechanical support pylon (13).

FIG. 5 is a front/back view of FIG. 4, showing how laser diodes (7), fiber optics (8), array (6), support structure (10), and power/control buss (11) are referenced to pod enclosure (15) and pylon (13).

FIG. 6 illustrates a vehicle (17), which is comprised of a payload/power section (16), pylons (13), and pods (15). Power/control for the pods (15) is provided by the payload/power section (16) through the pylons (15). The pylons (15) are a mechanical support for the pods (15) to the payload/power section (16).

FIG. 7 depicts the relationship of the pods (15) and pylons (13) with respect to the payload/power section (16) from a front/back perspective.

FIG. 8 illustrates the relationship of the pods (15) to the payload/power section (15) from a top/bottom perspective.

It is to be understood that while directional and attitude control have not been discussed herein since the present invention deals with propulsion only, such direction and attitude control can be achieved by conventional means, i.e., a plurality of nozzles (not shown) may be placed around the vehicle body and actuated by a known thrust vectoring control system carried on the vehicle.

It is further understood that the laser diodes and vibrator cells are commercially available. The diodes, for example, may similar to those distributed by Laser Diodes, Inc. and the cells are known in the art.

1. An asymmetrical gravity wave propulsion system to propel a vehicle to a predetermined point in space comprising:
a resonant vibrator array means carried by said vehicle for generating gravitational radiation which defines said propelling force;
laser diode means for converting laser light to vibrational energy;
fiber optic means connecting said vibrator array to said laser diode means whereby said vibration array in energized by said laser diode means.

2. A resonant vibrator cell as in claim 1 wherein said vibrator array means is comprised of a linear assembly of resonant vibrator cells, each cell being formed from a material capable of converting laser light to acoustic vibrations.

3. A resonant vibrator array as in claim 2 disposed for generating asymmetric radiation that can impart momentum to the radiation structure, thus creating a directional thrust.

4. A resonant vibrator as in claim 3 wherein said vehicle includes a pair of pods secured thereto by a respective pylon, said pods enclosing said resonant vibrator array and said laser diodes.

5. An asymmetrical gravity wave propulsion system as in claim 4 including a housing carried by said vehicle to support said resonant vibrator array means, said laser diodes and said fiber optics.

6. A resonant vibrator as in claim 5 wherein said pods are secured along said housing by a pair of pylons, said pylons providing means of electrical connection between said components carried in said pods and said housing.

7. A resonant vibrator as in claim 1 wherein said vibrator cells are comprised of quartz.

8. A resonant vibrator as in claim 1 wherein said vibrator cells are comprised of germanium.

9. A resonant vibrator as in claim 1 wherein said vibrator cells are comprised of barium titanate.

10. An asymmetrical gravity wave propulsion system comprising:
a body for travel in space;
a pair of pods secured to said body;
pylons secured to said pods and extending therefrom for secured relation with said body;
resonant vibrator means carried in at least one said pod;
laser diode means carried in at least one said pod and disposed to emit vibratory energy;
said vibrator means connected with said laser diodes for energization thereof.
